(19) United States
(12) Patent Application Publication
(10) Pub. No.: US 2021/0016295 A1
(43) Pub. Date: Jan. 21, 2021

(54) CENTRIFUGAL SEPARATOR WITH DISPOSABLE BOWL LINER

(71) Applicants: Robert Bret Carr, Durham, NC (US); Jing Liu, Somerville, MA (US)

(72) Inventors: Robert Bret Carr, Durham, NC (US); Jing Liu, Somerville, MA (US)

(21) Appl. No.: 16/933,615

(22) Filed: Jul. 20, 2020

Related U.S. Application Data
(60) Provisional application No. 62/875,690, filed on Jul. 18, 2019.

(51) Int. Cl. B04B 1/06; B04B 1/16; B04B 9/12; B04B 11/05; B04B 5/04

(52) U.S. Cl. CPC B04B 1/06; B04B 1/16; B04B 2005/0485; B04B 11/05; B04B 5/0442; B04B 9/12

(57) ABSTRACT

A centrifugal separator includes disposable cartridge having a cylindrical bowl, a core tube assembly, and an annular piston disposed around the core tube assembly and inside the inner surface of the bowl. The disposable cartridge may be automatically loaded and withdrawn from the separator. Feed liquid is injected down the core tube assembly into the lower portion of the bowl, raising the annular piston, while the bowl rotates at high speed, separating solids from the feed liquid to accumulate along the inner surface of the bowl, while collecting clarified centrate as it exits the top of the bowl and through the core tube assembly. In a solids discharge mode, the annular piston is urged downward along a vertical axis to force accumulated solids from the bowl.

### CROSS-REFERENCE TO RELATED APPLICATIONS

This application claims the benefit of priority to U.S. Patent Application No. 62/875,690, filed on Jul. 18, 2019, the entire disclosure of which is incorporated herein by reference.

### FIELD

The instant disclosure relates to centrifuges, and in particular to a disposable cartridge for use with a centrifuge enabling automatic discharge of solids that accumulate during separation.

### BACKGROUND

Many different types of centrifugal separators are known for separating heterogeneous mixtures into components based on specific gravity. A heterogeneous mixture, which may also be referred to as feed material or feed liquid, is injected into a rotating bowl of the separator. The bowl rotates at high speeds and forces particles of the mixture, having a higher specific gravity, to separate from the liquid by sedimentation. As a result, a dense solids cake compresses tightly against the surface of the bowl, and the clarified liquid, or “centrate”, forms radially inward from the solids cake. The bowl may rotate at speeds sufficient to produce forces 20,000 times greater than gravity to separate the solids from the centrate. The solids accumulate along the wall of the bowl, and the centrate is drained off. Once it is determined that a desired amount of the solids has been accumulated, the separator is placed in a discharge mode. Various types of scrapers may be used to scrape sides of the bowl towards a discharge outlet in the bottom. The discharge outlet typically includes a valve that may be operated manually or automatically so that solids may exit the bowl and be collected in a separate container.

A centrifugal separator may include a cylindrical separator bowl, a core tube assembly for introducing a feed fluid and removing centrate, and an annular piston for extruding accumulated solids through a shuttle valve in the bottom of the bowl following centrifugation. A representative centrifugal separator is shown and described in U.S. Pat. No. 10,449,555, incorporated by reference and shown in FIG. 1.

FIG. 1 shows a prior art centrifugal separator in vertical section. The centrifugal separator includes a cylindrical separator bowl 10 mounted in a central region 11 of a separator housing 14. The cylindrical separator bowl 10 rotates around a central vertical axis 13. Core tube assembly 16 is disposed axially along the interior length of bowl 10 for moving feed fluid into the separator bowl 10 and clarified centrate out of the separator bowl 10. Annular solids discharge piston 18 is disposed within bowl 10 for extruding accumulating solids out of the separator bowl 10. As shown, the annular piston 18 may have a lower conical portion that matches the shape of a lower conical end 17 of the separator bowl 10. The conical lower end 17 acts as a rotational accelerator of the feed liquid during a feed mode of operation for the separator.

Core tube assembly 16 includes a pull rod 20 inside a pull rod support 22. A feed liquid port 23 above the separator housing 14 is in communication with a feed tube 24 inside of pull rod 20. Pull rod 20 is operably connected to a shuttle valve 26 in the lower portion of separator bowl 10, and is described in further detail below. The lower end of feed tube 24 is coupled to shuttle valve 26 which is proximate an opening in the lower end of separator bowl 10, and may be opened and closed via pull rod 20.

Also shown in FIG. 1 is a centrate port 28 for removing clarified centrate created by the centrifugation of the feed liquid. Centrate port 28 is in liquid communication with a centrate tube 30 that surrounds and extends along the exterior length of feed tube 24. Centrate port 28 is in liquid communication with the interior of separator bowl 10 via a centrate passage 29 in core tube assembly 16, allowing centrate to be withdrawn from the spinning separator bowl during separation mode, as further discussed below.

The centrifugal separator includes main shaft 32 on the upper portion of cylindrical separator bowl 10. Main shaft 32 operatively connects to a spherically mounted bearing and spindle assembly 40. A drive belt 33 is operatively coupled to a drive motor (not shown) that may be controllably operated to rotate the separator bowl 10 at desired speeds for separating the feed liquid. Separators described herein can also be operated using other motor and drive systems. A seal assembly 34 for main shaft 32 is also shown in FIG. 1. Seal assembly 34 allows fluid communication of the feed port 23, centrate port 28 and seal cooling input port 36 along main shaft 32, while allowing main shaft 32, tube assembly 16 and separator bowl 10 to spin.

FIG. 1 also shows a discharge case 50 as well isolation valve 54. The upper end of separator bowl 10 includes gas passages 56 in gas communication with the inside of separator bowl 10 and the top surface of annular piston 18. Isolation valve 54 is open as the feed liquid enters the bowl 10 in fill mode and in feed mode, allowing gas (e.g. air) displaced by upward movement of annular piston 18 to pass between the discharge case 50 and central region 11. When closed, such as during solids discharge mode, isolation valve 54 prevents gas from moving between discharge case 50 and central region 11, creating a closed system in discharge case 50. Compressed gas (e.g. air) may then be injected into discharge case 50 to force annular piston 18 downward. Isolation valves 54 open and close in a vertical motion. Isolation valve 54 may comprise an annular member, preferably disposed thereabout, and may be urged upward or downward by compressed fluid, such as compressed gas or hydraulic liquid, that acts against a piston or diaphragm in isolation valve 54.

As shown in FIG. 1, annular solids discharge piston 18 surrounds core tube assembly 16 and is able to slide along the length of core tube assembly 16 and separator bowl 10. Annular solids discharge piston 18 is forced downward during the solids discharge phase using gas pressure (e.g. air). The tight clearance between annular solids discharge piston 18, separator bowl 10, and outer diameter of core tube assembly 16 ensures that minimal solids are retained in separator bowl 10 following completion of the solids discharge phase of operation. As annular piston 18 is urged down separator bowl 10, solids are discharged through the opening at the lower end of bowl 10 and into a solids discharge area 58. Principles of operation of the centrifugal separator of FIG. 1 are similar to those described in U.S. Pat. No. 10,449,555, incorporated by reference.

After a quantity of feed material has been separated, it is necessary to clean and sterilize the separator. This tends to be difficult in conventional separators without significantly increasing maintenance costs, especially for companies who may use one machine for several different processes, thus requiring frequent cleaning and sterilization.

It is desirable to have a centrifugal separator that uses a disposable separator bowl liner. There is a further need to load new liners and unload used liners with minimal interaction from an operator to minimize external contamination.

### SUMMARY

The present disclosure provides a disposable cartridge for a centrifugal separator for separating sticky solids from a feed liquid and discharging the accumulated solids. In one aspect, the a centrifugal separator includes a separator housing, a spindle assembly, a main shaft retained within the spindle assembly for rotation therein and a cylindrical separator bowl, the cylindrical separator bowl having an upper end coupled to the main shaft and a lower end with an opening, the cylindrical separator bowl suspended within the separator housing from the main shaft and operative during a separation mode of operation to rotate at a high speed relative to the spindle assembly to separate feed liquid into centrate and solids, and the disposable cartridge includes a unitary bowl and support structure having a stainless steel cylindrical liner portion conforming to an inner wall of the cylindrical separator bowl and having an opening at the lower end thereof, a shaft liner conforming to an inner wall of the main shaft and in mechanical communication with the cylindrical liner portion at an upper extent thereof, and a pull rod support disposed axially along the interior length of the cylindrical separator bowl and in mechanical communication with the shaft liner at a lower extent thereof and the cylindrical bowl liner portion at a lower extent thereof; a pull rod disposed axially along the interior length of the pull rod support and the shaft liner and comprising a shuttle valve operative for axial movement relative to the pull rod support to open and close the opening in the lower end of the cylindrical liner portion; and an annular piston disposed between an inner surface of the cylindrical liner portion and an outer surface of the pull rod support, the annular piston being operative for axial movement to selectively discharge solids out of the opening in the lower end of the cylindrical liner portion.

In a further embodiment, the pull rod includes a feed tube along a first interior length of the pull rod and a feed bore along a second interior length of the pull rod, the feed tube and feed bore forming a feed flow path through the length of the pull rod and wherein the feed flow path is in fluid communication with the interior of the cylindrical liner portion when the shuttle valve has closed the opening in the lower end of the cylindrical liner portion.

In another embodiment, the feed flow path is in fluid communication with the interior of the cylindrical liner portion via at least one feed acceleration channel disposed in the shuttle valve. Further, the pull rod support includes at least one slot intermediate the interior of the cylindrical liner portion and the opening in the lower end of the cylindrical liner portion, wherein solids may be extruded out of the opening in the lower end of the cylindrical liner portion through the at least one slot by the annular piston when the lower portion of the shuttle valve has opened the opening in the lower end of the cylindrical liner portion.

In yet another embodiment, the pull rod support includes plural lateral centrate passages, each having an opening on the outer surface of the pull rod support, wherein the pull rod comprises a centrate channel intermediate a feed tube outer surface and a pull rod inner surface, the plural centrate passages being in fluid communication with the centrate channel, and wherein the centrate channel is in fluid communication with a centrate port, thereby allowing removal of centrate from the cylindrical liner portion.

In any of the above embodiments, the disposable cartridge further includes at least one coupler at an upper end of the shaft liner for coupling to a feed port and a centrate port.

In any of the above embodiments, the annular piston includes at least one magnet, and the separator housing comprises an array of magnetic sensors for detecting the position of the annular piston through selective interaction with the at least one annular piston magnet.

In any of the above embodiments, the lower end of the cylindrical liner portion and a lower portion of the annular piston are complementarily shaped.

In any of the above embodiments, wherein the lower end of the cylindrical liner portion and the lower portion of the annular piston are substantially conically shaped.

In an embodiment, a method for discharging solids from a centrifugal separator comprising a disposable cartridge includes providing a centrifugal separator comprising a separator housing and a cylindrical separator bowl, the cylindrical separator bowl having an upper end, and a lower end with an opening, the cylindrical separator bowl disposed in the separator housing and operative during a separation mode of operation to rotate at a high speed to separate feed liquid into centrate and solids; providing a disposable cartridge including a cylindrical liner conforming to an inner wall of the cylindrical separator bowl; shaft liner conforming to the main shaft; a pull rod support in mechanical communication with the shaft liner at a lower extent thereof and with the cylindrical liner at a lower extent thereof and disposed axially along the interior length of the disposable cartridge, the core tube assembly comprising a shuttle valve operative for axial movement to open and close an opening in the lower end of the cylindrical separator bowl; an annular piston disposed between an inner surface of the cylindrical liner and an outer surface of the core tube assembly, the annular piston being operative for axial movement to discharge solids out of the opening in the lower end of the disposable bowl liner; a process seal coupler operatively coupled to an upper end of the shaft liner; and a cap for securing a lower end of the cylindrical liner within the cylindrical separator bowl; securing the disposable cartridge within the cylindrical separator bowl via the process seal coupler and the cap; and introducing gas to press against an upper surface of the annular piston to drive the annular piston downward to discharge solids accumulated within the cylindrical liner through the opening in the lower end of the cylindrical liner portion.

In a further embodiment, the pull rod support further includes a pull rod disposed axially along the interior length of the pull rod support and the shaft liner and in mechanical communication with the shuttle valve at a respective lower extent thereof, wherein the pull rod comprises a feed tube along a first interior length of the pull rod and a feed bore along a second interior length of the pull rod, the feed tube and feed bore forming a feed flow path through the length of the pull rod and wherein the feed flow path is in fluid communication with the interior of the cylindrical liner when the shuttle valve has closed the opening in the lower end of the cylindrical liner, the method further including selectively positioning the pull rod in a downward position whereby the shuttle valve has closed the opening in the lower end of the cylindrical liner; flowing feed liquid having a solids component suspended therein through the feed flow path and into the interior of the cylindrical liner via the shuttle valve; and rotating the cylindrical separator bowl whereby the feed liquid is separated into solids that accumulate on an inner surface of the cylindrical liner below the annular piston and centrate.

In another embodiment, the method includes drawing the pull rod upwardly within the pull rod support prior to the step of introducing gas to press against an upper surface of the annular piston support, whereby the shuttle valve has opened the opening in the lower end of the disposable bowl liner.

In a further embodiment, flowing the feed liquid further includes flowing the feed liquid into the interior of the cylindrical liner via at least one feed acceleration channel disposed in the shuttle valve.

In a further embodiment, the pull rod support includes plural lateral centrate passages, each having an opening on the outer surface of the pull rod support, and a centrate channel intermediate a feed tube outer surface and a pull rod inner surface, the plural centrate passages being in fluid communication with the centrate channel, and the method further includes flowing the centrate through the plural centrate passages, into the centrate channel, and to an exit thereof.

In yet another embodiment, the method includes stopping the rotation of the cylindrical separator bowl prior to the step of introducing gas to press against an upper surface of the annular piston.

In any of the above embodiments, the method includes after the step of introducing gas to press against an upper surface of the annular piston, removing the process seal coupler and the cap from the disposable cartridge and removing the disposable cartridge from the cylindrical separator bowl.

### BRIEF DESCRIPTION OF THE FIGURES

FIG. 1 is a section view of a centrifugal separator according to the prior art.

FIG. 2 is a section view of a disposable cartridge according to the present disclosure as it is inserted into a centrifugal separator, in an embodiment.

FIG. 3 is a section view of the disposable cartridge of FIG. 2 fully inserted into a centrifugal separator, in an embodiment.

FIG. 4 shows a detailed view of elements of the disposable cartridge of FIG. 2, in embodiments.

FIG. 5 shows side view of a loading mechanism for inserting and withdrawing the disposable cartridge of FIG. 2 in a centrifuge.

FIG. 6 is a section view that illustrates principles of operation of the disposable cartridge of FIG. 2 in a centrifuge, in embodiments.

FIGS. 7A and 7B are expanded section views of upper and lower portions of centrifugal separator 104 and disposable cartridge 70 of FIG. 6, respectively.

### DETAILED DESCRIPTION

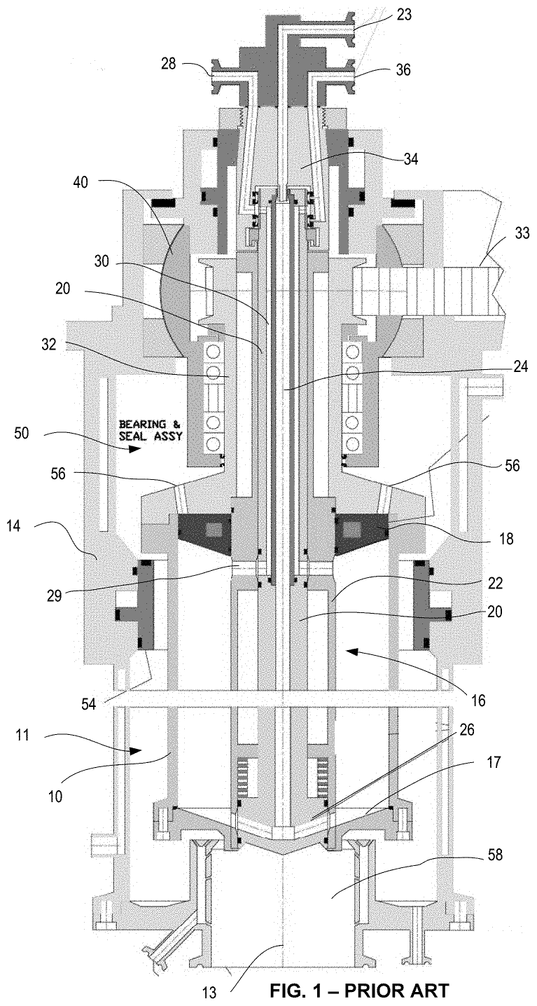

The centrifugal separator of FIG. 1 must be cleaned and maintained regularly. A clean-in-place (CIP) and sterilize-in-place (SIP) process uses various ports and drains so that one or more cleaning solutions may be circulated through the separator. CIP and SIP processes may be time-consuming and expensive, especially when small batches of feed fluid are processed, thus requiring frequent cleanings. In embodiments, the centrifugal separator of FIG. 1 may be adapted for use with a disposable cartridge for Disposable Process Contact (DPC) or single use operation.

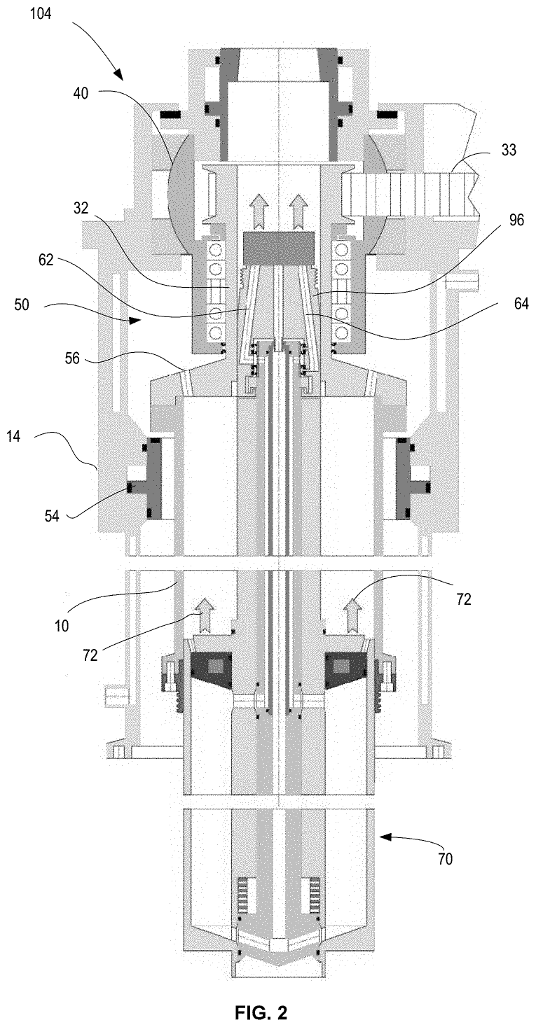

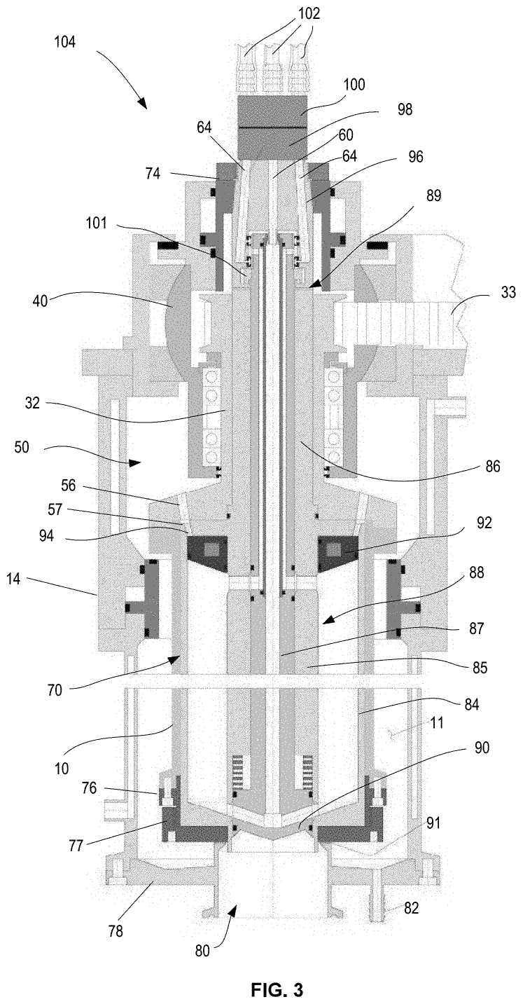

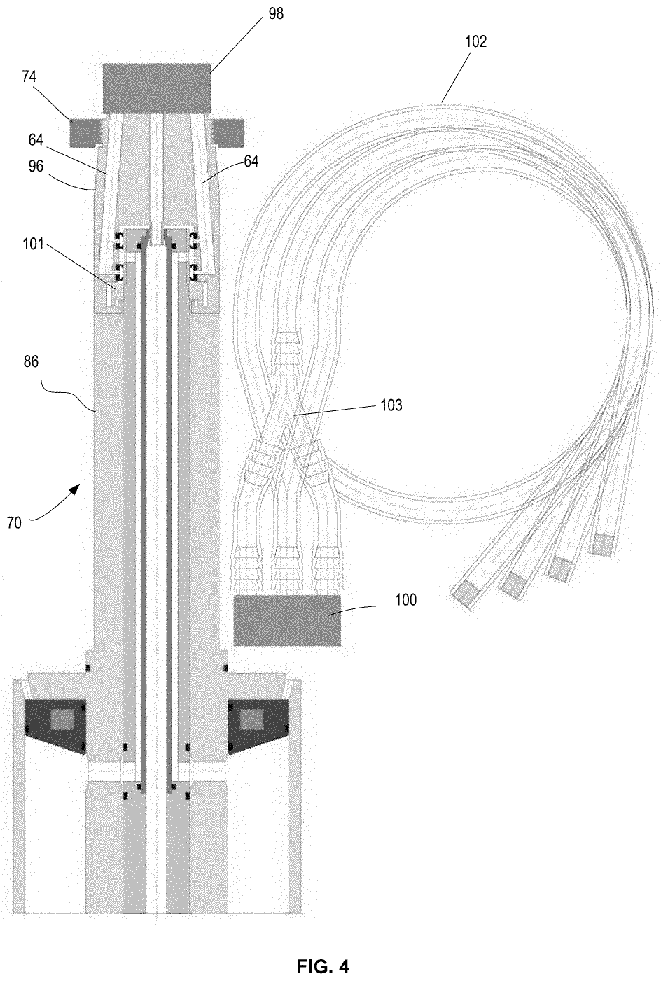

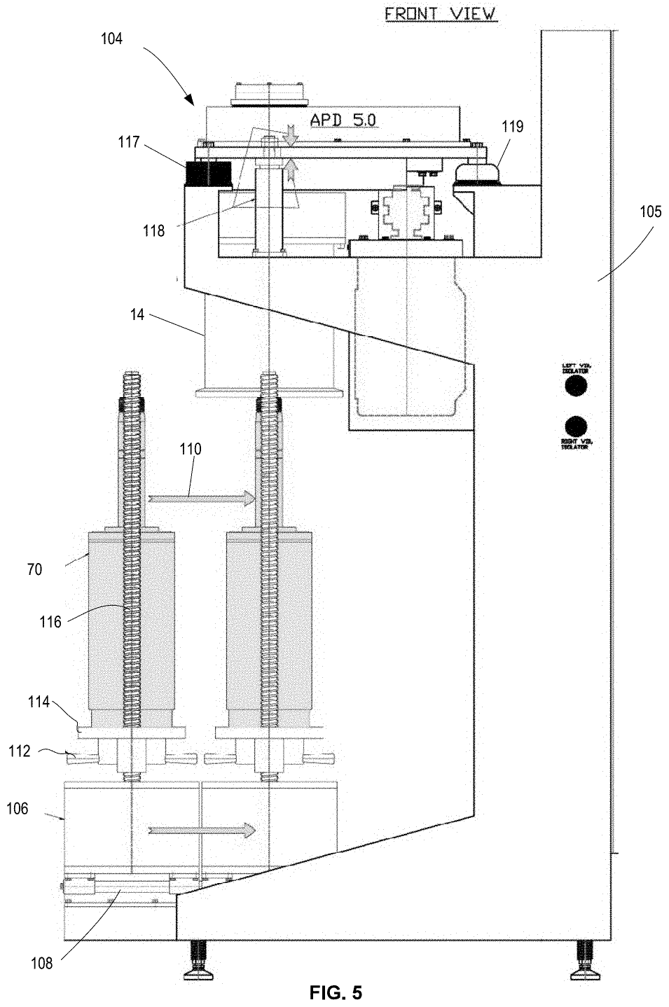

FIGS. 2-4 show a disposable cartridge 70 for use with a centrifugal separator 104. FIG. 2 shows disposable cartridge 70 as it is being inserted into centrifugal separator, FIG. 3 shows disposable cartridge 70 fully inserted, and FIG. 4 shows a more detailed view of elements of disposable cartridge 70. FIGS. 2-4 are best viewed together in the following description. Referring to FIG. 2, separator bowl 10 and main shaft 32 are adapted to be spun within spherically mounted bearing and spindle assembly 40 by means of drive belt 33 attached to a motor (not shown). Disposable cartridge 70 is inserted from the bottom of separator bowl 10 as shown by arrows 72 and shown in FIG. 5, described below. In embodiments, disposable cartridge 70 may be fabricated from Class VI plastic materials.

FIG. 3 shows disposable cartridge 70 installed in centrifugal separator 104, in embodiments. After insertion, cartridge 70 is retained within the centrifugal separator 104 by hand nut 74 at the top of disposable cartridge 70. Bowl adapter ring 76 is installed at the lower end of separator bowl 10 when converting centrifugal separator 104 for use with disposable cartridge 70. After insertion of disposable cartridge 70, clamp ring 77 is threaded onto bowl adapter ring 76. Clamp ring 77 and bowl adapter ring 76 cooperate to slightly compress cartridge 70 within separator bowl 10. This helps ensure that disposable cartridge 70 rotates at the same speed as separator bowl 10.

A disposable bottom cap 78 is attached to housing 14 to help secure cartridge 70 in the centrifugal separator 104. Bottom cap 78 also includes solids discharge outlet 80 and cartridge leakage drain 82. A tight labyrinth gap 91 is formed between disposable bottom cap 78 and clamp ring 77 to help prevent solid and centrate from leaking from solids discharge outlet 80 into central region 11 of housing 14. In embodiments, hand nut 74, bowl adapter ring 76, clamp ring 77 and bottom cap 78 may be fabricated from Class VI plastic materials.

Cartridge 70 includes a cylindrical liner portion 84 adapted to fit within separator bowl 10 and a shaft liner 86 adapted to fit within main shaft 32. Core tube assembly 88 is disposed axially along the interior length of assembly 70. Core tube assembly 88 includes pull rod 87 disposed within pull rod support 85. Shuttle valve 90 is located at a lower end of liner portion 84 and may be opened and closed using pull rod 87. Annular piston 92 is disposed within the cylindrical liner portion 84 and is used to remove solids from disposable cartridge 70. Gas passages 94 in cartridge 70 communicate with gas passages 56 in separator bowl 10 via a recessed shoulder ring 57 at the upper extent of the cylindrical liner portion 84 so that compressed gas injected into discharge case 50 may force annular piston 94 downward to remove solids when shuttle valve 90 is raised and opened by core tube assembly 88. The recessed shoulder ring 57 enables communication between the gas passages 56 and gas passages 94 without requiring alignment therebetween.

Solids discharge outlet 80 receives solids from disposable cartridge 70. In embodiments, outlet 80 may discharge solids to a variety of containers, such as an Ezi-Dock® aseptic valve with a plastic paste collection bag, or a paste bag with disposable re-suspension agitator from Pall Corporation.

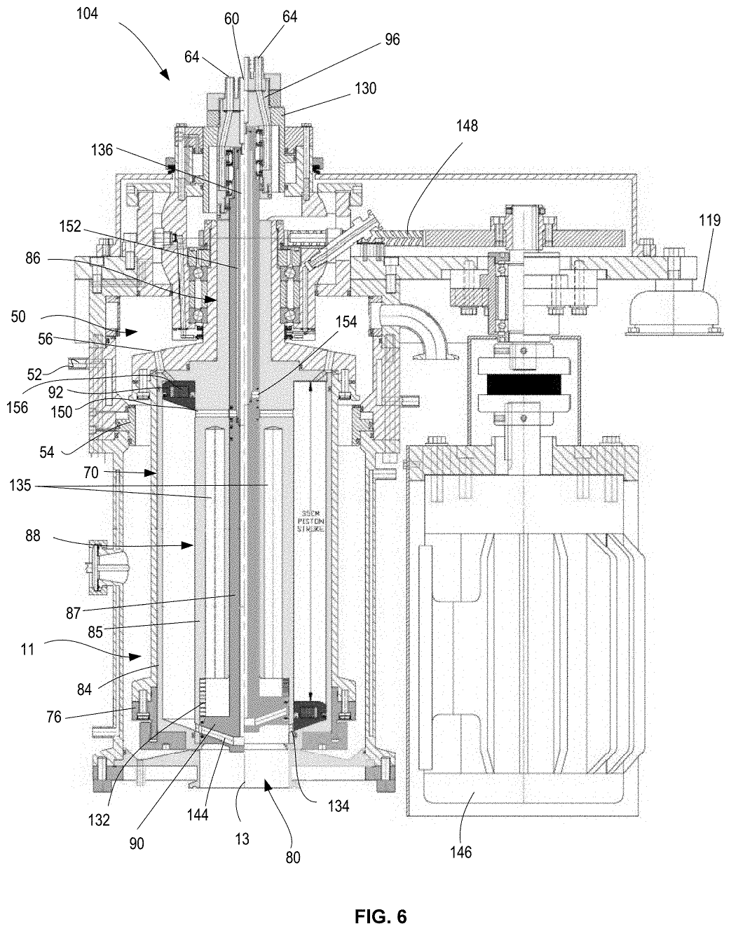

With reference to FIGS. 3 and 4, seal assembly 96 allows fluid communication of feed port 60, and two seal cooling input ports 64 in a plane along main shaft 32. Seal assembly 96 also includes two centrate ports 62, located in a plane perpendicular to the plane of the two seal cooling ports as discussed below. In FIG. 2, on the left side of a vertical axis of symmetry, one of two centrate ports 62 is shown, whereas on the right side of the vertical axis of symmetry, one of two seal cooling input port 64 is shown. It is understood that the two centrate ports 62 and the two seal cooling ports 64 normally lie in respective orthogonal planes about the axis of symmetry. Seal assembly 96 is separated from shaft liner 86 at line 89, which main shaft 32, separator bowl 10 and portions of disposable cartridge 70 below line 89 to spin. Seal assembly 96 remains stationary during operation of centrifugal separator 104. Seal assembly 96 is capped with lower coupler 98. Lower coupler 98 is part of disposable cartridge 70. Upper coupler 100 is attached to lower coupler 98 to couple feed, centrate and seal cooling ports with appropriate components in the centrifugal separator to plastic tubing 102. In embodiments, centrate ports 62 may be joined by Y-coupler 103 to provide a single centrate output tube 102. Lower coupler 98 and upper coupler 100 may be a type of rotary union coupler available from Cole-Parmer®, for example. In embodiments, seal assembly 96 couples with pull rod 87 through snap ring 101 for purposes of opening and closing shuttle valve 90, as shown in FIG. 6 and described below.

FIG. 5 shows an apparatus for loading disposable cartridge 70 into centrifuge 104. Loading base 106 is mounted to ball slide rails 108 for sliding in and out of support frame 105 of centrifuge 104 in the direction of arrow 110. Clamping mechanism 112 holds cartridge 70 securely during insertion and retraction of cartridge 70 from centrifuge 104 using ball screw mechanism 116. The operation of ball slide rails 108 and ball screw mechanism 116 may be computer controlled by a suitable processing device.

Due to the high rate of speed achieved by centrifugal separator 104, vibration bushings 117 and 119 are provided to isolate support frame 105. The flexibility afforded by vibration bushings 117 and 119 may make it difficult to insert disposable cartridge 70. Frame and case motion lock cylinder 118 prevents support frame 105 and housing 14 from moving while the cartridge 70 is removed or inserted. After cartridge 70 is inserted in centrifuge 104, hand nut 74 (FIG. 3) is installed around coupler 98 of cartridge 70, then clamp 112 is released and loading base 106 slides away from frame 105. Then clamp ring 77 is installed to secure cartridge 70 within housing 14 of centrifugal separator 104, and bottom cap 78 is installed.

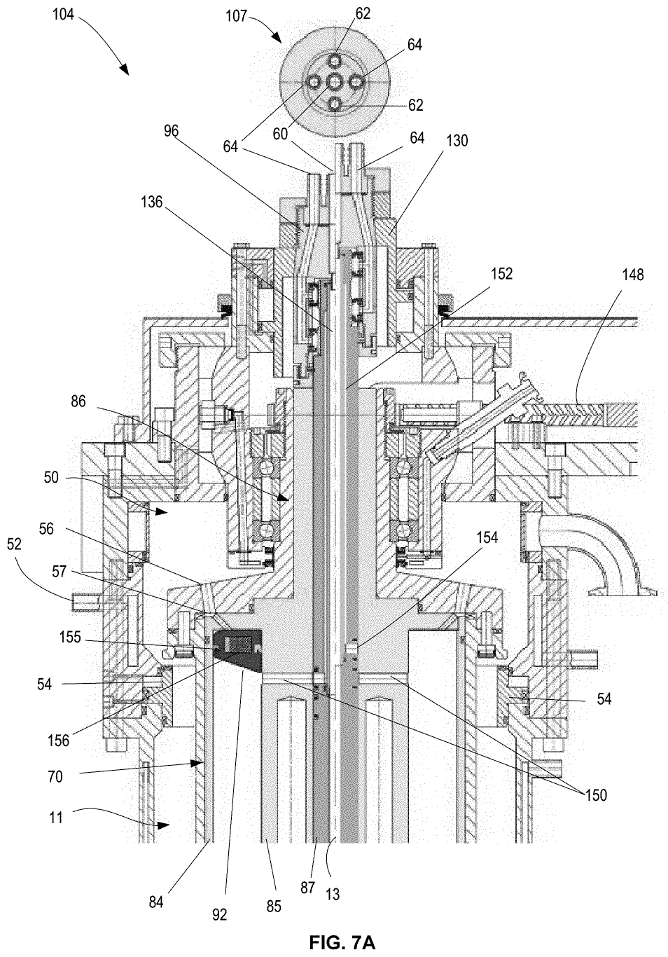

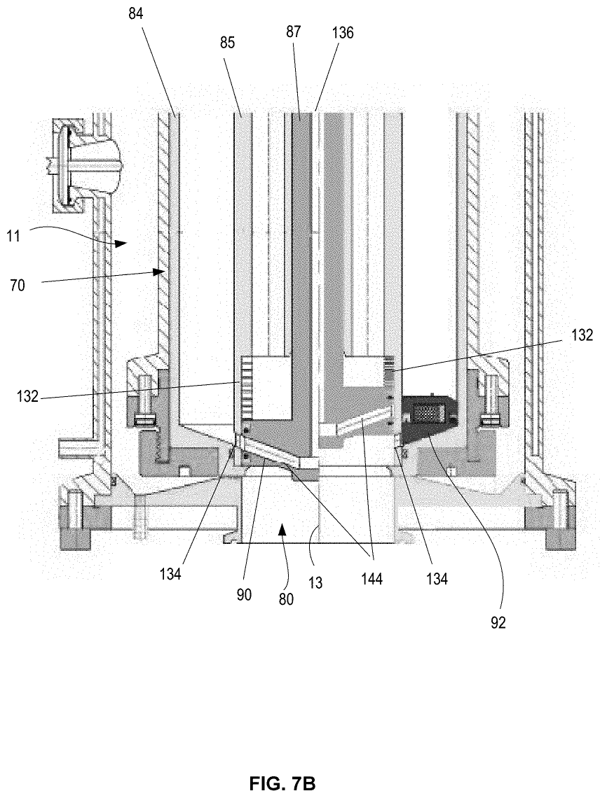

The operation of disposable cartridge 70 with a centrifugal separator will now be described. In embodiments, FIG. 6 shows disposable cartridge 70 inserted into centrifuge 104. An expanded view of upper and lower portions of centrifugal separator 104 and disposable cartridge 70 are shown in FIGS. 7A and 7B respectively. FIGS. 6, 7A and 7B are best viewed together in the following description. On the left side of central vertical axis 13, seal assembly 96 is in a lowered position, shuttle valve 90 is closed and annular piston 92 is at the top of cylindrical liner portion 84. On the right side of central vertical axis 13, seal assembly 96 is in a raised position, shuttle valve 90 is open and annular piston 92 is shown at the bottom of the cylindrical liner portion. This depiction will be used to illustrate principles of operation. As noted above, centrate ports 62 are in a plane on opposite sides of seal assembly 96. FIGS. 6 and 7A show seal cooling ports 64 in a plane that is perpendicular to the plane of centrate ports 62, as shown in a top view 107 of seal assembly 96 in FIG. 7A.

During a fill mode of operation, cartridge 70 (and separator bowl 10) are not spinning, as it is being filled with feed fluid or buffer liquid. Isolation valve 54 is open, allowing gas (e.g. air) to pass between the discharge case 50 and central region 11. Shuttle valve 90 is urged into a closed position within the opening in the lower end of the cylindrical liner portion 84 by operation of the shuttle valve actuator 130 and by pressure provided by spring 132, located between pull rod 87 and pull rod support 85. Feed fluid is introduced through feed port 60 and down through feed tube 136, exiting into the lower end of the cylindrical liner portion 84 through feed acceleration channels 144 of shuttle valve 90. The feed acceleration channels 144 are angled slightly upward, at the same angle as the lower end of the cylindrical liner portion 84, to create angular acceleration of feed liquid as it enters the cylindrical liner portion 84. Cylinders 135 may be machined inside core tube assembly 88 to reduce weight. In embodiments, there may be 2-8 cylinders around the circumference of core tube assembly 88.

At the beginning of the bowl fill mode, annular piston 92 is positioned at the bottom of the cylindrical liner portion 84. As feed fluid is introduced into the cylindrical liner portion 84, the increasing volume of feed liquid inside the cylindrical liner portion 84 urges annular piston 92 upward, minimizing air contact with the feed liquid. This lack of air/liquid interface reduces foaming and oxidation of the feed liquid and thus ensuring the solids in the feed liquid are better preserved during the separation process.

Next, during separation mode, separator bowl 10 together with disposable cartridge 70 are spun at high speed by motor 146 and drive belt 148 to separate solid particles suspended in the feed liquid. As the feed liquid exits feed acceleration channels 144 into the cylindrical liner portion 84, Coriolis acceleration effects track the feed liquid along the outer diameter of core tube assembly 88 to the top of the cylindrical liner portion 84 and into at least one centrate passage 150 which terminates in a ring-shaped depression in pull rod support 85. The presence of a ring-shaped depression allows some alignment flexibility between centrate passage 150 and a corresponding centrate passage in pull rod 87. The centrate continues into a corresponding centrate passage 154 in the pull rod 87, travels up centrate tube 152 between shaft liner 86 and feed tube 136, then out of the centrifugal separator via centrate ports 62. O-ring seals that are above and below the exterior termination of 154 and are also on the pull rod 87 to seal passages 150 when the pull rod 87 is pulled upward.

Separated solids collect on the inner diameter of the cylindrical liner portion 84, packing into a cake with paste-like consistency. As centrate is removed, additional feed liquid may be introduced via feed tube 136. The sedimentation of feed liquid may continue until the desired bowl volume of solids is reached (e.g., 25% to 98% of bowl volume filled with solids). In embodiments, other methods of determining when to stop providing feed liquid to the cylindrical liner portion 84 may also be used.

Finally, in solids discharge mode, rotation ceases and shuttle valve actuator 130 is actuated to open shuttle valve 90, while compressing spring 132 as shown on the right side of FIG. 7B. Shuttle valve actuator 130 uses compressed gas or hydraulic fluid to raise and lower pull rod 87 and thus, shuttle valve 90. Opening shuttle valve 90 exposes slots 134 in the core tube assembly 88. Slots 134 provide a passage for solids to be extruded from the inside of the cylindrical liner portion 84. During solids discharge mode, isolation valve 54 is closed, preventing passage of gas or air between discharge case 50 and central region 11. This creates an air-tight closed system between gas port 52, gas passages 56 in the upper end of separator bowl 10, and the top surface of annular piston 92. Raising pull rod 87 also causes passage 154 in pull rod 87 to be moved out of alignment with centrate passage 150 to further seal the system.

Isolation valve 54 is closed while gas (e.g. air) pumped into gas port 52 and through passage 56 urges annular piston 92 downward. O-ring seal 155 is provided to provide a seal between the annular piston 92 and cylindrical liner portion 84 and pull rod support 85. As annular piston 92 moves downward through cylindrical liner portion 84, accumulated solids are extruded through slots 134 then out of opening 80. Once the annular piston 92 has reached the bottom of its stroke, shuttle valve 90 is closed using shuttle valve actuator 130 and/or spring 132. The process of closing shuttle valve 90 covers slots 134 in core tube assembly 88 with the outer surface of shuttle valve 90, and thereby severs any remaining tube of accumulated solids paste hanging from the opening in cylindrical liner portion 84.

Annular piston 92 includes magnet 156 which may be used by reed switches or corresponding magnetic sensors disposed along the outside of housing 14 to sense a position of annular piston 92 as it moves up and down within the cylindrical liner portion 84. Magnetic sensors may be placed in a variety of locations inside or outside of housing 14 as long as they are able to sense the vertical position of magnet 156. These sensors enable an associated controller to have an accurate determination of the position of the annular piston 92 within the cylindrical liner portion 84.

While the present invention has been described in conjunction with a preferred embodiment, one of ordinary skill in the art, after reading the foregoing specification, will be able to effect various changes, substitutions of equivalents and other alterations to the compositions, articles, methods and apparatuses set forth herein. For example, fluid pressure may be replaced in other embodiments by, without limitation, an electromechanical force. Similarly, the lower portion and end of the piston and bowl, respectively, may not be conical in shape, although it is preferable for solids recovery that their shapes be complimentary.

Moreover, the invention also contemplates that the various passages, valves, pistons, actuators, assemblies, ports, members and the like described herein can be in any configuration or arrangement that would be suitable for operation of a centrifugal separator. The embodiments described above may also each include or incorporate any of the variations of all other embodiments. It is therefore intended that the protection granted by Letter Patent hereon be limited only by the definitions contained in the appended claims and equivalents thereof.

What is claimed:

1. A disposable cartridge for a centrifugal separator comprising a separator housing, a spindle assembly, a main shaft retained within the spindle assembly for rotation therein and a cylindrical separator bowl, the cylindrical separator bowl having an upper end coupled to the main shaft and a lower end with an opening, the cylindrical separator bowl suspended within the separator housing from the main shaft and operative during a separation mode of operation to rotate at a high speed relative to the spindle assembly to separate feed liquid into centrate and solids, the cartridge comprising:
a unitary bowl and support structure, comprising
a stainless steel cylindrical liner portion conforming to an inner wall of the cylindrical separator bowl and having an opening at the lower end thereof,
a shaft liner conforming to an inner wall of the main shaft and in mechanical communication with the cylindrical liner portion at an upper extent thereof, and
a pull rod support disposed axially along the interior length of the cylindrical separator bowl and in mechanical communication with the shaft liner at a lower extent thereof and the cylindrical bowl liner portion at a lower extent thereof,
a pull rod disposed axially along the interior length of the pull rod support and the shaft liner and comprising a shuttle valve operative for axial movement relative to the pull rod support to open and close the opening in the lower end of the cylindrical liner portion; and
an annular piston disposed between an inner surface of the cylindrical liner portion and an outer surface of the pull rod support, the annular piston being operative for axial movement to selectively discharge solids out of the opening in the lower end of the cylindrical liner portion.

2. The disposable cartridge of claim 1, wherein the pull rod comprises a feed tube along a first interior length of the pull rod and a feed bore along a second interior length of the pull rod, the feed tube and feed bore forming a feed flow path through the length of the pull rod and wherein the feed flow path is in fluid communication with the interior of the cylindrical liner portion when the shuttle valve has closed the opening in the lower end of the cylindrical liner portion.

3. The disposable cartridge of claim 2, wherein the feed flow path is in fluid communication with the interior of the cylindrical liner portion via at least one feed acceleration channel disposed in the shuttle valve.

4. The disposable cartridge of claim 2, wherein the pull rod support comprises at least one slot intermediate the interior of the cylindrical liner portion and the opening in the lower end of the cylindrical liner portion, wherein solids may be extruded out of the opening in the lower end of the cylindrical liner portion through the at least one slot by the annular piston when the lower portion of the shuttle valve has opened the opening in the lower end of the cylindrical liner portion.

5. The disposable cartridge of claim 2, wherein the pull rod support comprises plural lateral centrate passages, each having an opening on the outer surface of the pull rod support,
wherein the pull rod comprises a centrate channel intermediate a feed tube outer surface and a pull rod inner surface, the plural centrate passages being in fluid communication with the centrate channel, and
wherein the centrate channel is in fluid communication with a centrate port, thereby allowing removal of centrate from the cylindrical liner portion.

6. The disposable cartridge of claim 1, wherein the disposable cartridge further comprises at least one coupler at an upper end of the shaft liner for coupling to a feed port and a centrate port.

7. The disposable cartridge of claim 1, wherein the annular piston comprises at least one magnet, and the separator housing comprises an array of magnetic sensors for detecting the position of the annular piston through selective interaction with the at least one annular piston magnet.

8. The disposable cartridge of claim 1, wherein the lower end of the cylindrical liner portion and a lower portion of the annular piston are complementarily shaped.

9. The disposable cartridge of claim 1, wherein the lower end of the cylindrical liner portion and the lower portion of the annular piston are substantially conically shaped.

10. A method for discharging solids from a centrifugal separator comprising a disposable cartridge, the method comprising:
providing a centrifugal separator comprising a separator housing and a cylindrical separator bowl, the cylindrical separator bowl having an upper end, and a lower end with an opening, the cylindrical separator bowl disposed in the separator housing and operative during a separation mode of operation to rotate at a high speed to separate feed liquid into centrate and solids;
providing a disposable cartridge comprising:
a cylindrical liner conforming to an inner wall of the cylindrical separator bowl;
shaft liner conforming to the main shaft;
a pull rod support in mechanical communication with the shaft liner at a lower extent thereof and with the cylindrical liner at a lower extent thereof and disposed axially along the interior length of the disposable cartridge, the core tube assembly comprising a shuttle valve operative for axial movement to open and close an opening in the lower end of the cylindrical separator bowl;
an annular piston disposed between an inner surface of the cylindrical liner and an outer surface of the core tube assembly, the annular piston being operative for axial movement to discharge solids out of the opening in the lower end of the disposable bowl liner;
a process seal coupler operatively coupled to an upper end of the shaft liner; and
a cap for securing a lower end of the cylindrical liner within the cylindrical separator bowl;
securing the disposable cartridge within the cylindrical separator bowl via the process seal coupler and the cap; and
introducing gas to press against an upper surface of the annular piston to drive the annular piston downward to discharge solids accumulated within the cylindrical liner through the opening in the lower end of the cylindrical liner portion.

11. The method of claim 10, wherein the pull rod support further comprises a pull rod disposed axially along the interior length of the pull rod support and the shaft liner and in mechanical communication with the shuttle valve at a respective lower extent thereof,
wherein the pull rod comprises a feed tube along a first interior length of the pull rod and a feed bore along a second interior length of the pull rod, the feed tube and feed bore forming a feed flow path through the length of the pull rod and wherein the feed flow path is in fluid communication with the interior of the cylindrical liner when the shuttle valve has closed the opening in the lower end of the cylindrical liner,
the method further comprising:
selectively positioning the pull rod in a downward position whereby the shuttle valve has closed the opening in the lower end of the cylindrical liner;
flowing feed liquid having a solids component suspended therein through the feed flow path and into the interior of the cylindrical liner via the shuttle valve; and
rotating the cylindrical separator bowl whereby the feed liquid is separated into solids that accumulate on an inner surface of the cylindrical liner below the annular piston and centrate.

12. The method of claim 11, further comprising drawing the pull rod upwardly within the pull rod support prior to the step of introducing gas to press against an upper surface of the annular piston support, whereby the shuttle valve has opened the opening in the lower end of the disposable bowl liner.

13. The method of claim 11, wherein flowing the feed liquid further comprises flowing the feed liquid into the interior of the cylindrical liner via at least one feed acceleration channel disposed in the shuttle valve.

14. The method of claim 11, wherein the pull rod support comprises plural lateral centrate passages, each having an opening on the outer surface of the pull rod support, and a centrate channel intermediate a feed tube outer surface and a pull rod inner surface, the plural centrate passages being in fluid communication with the centrate channel,
the method further comprising flowing the centrate through the plural centrate passages, into the centrate channel, and to an exit thereof.

15. The method of claim 11, further comprising stopping the rotation of the cylindrical separator bowl prior to the step of introducing gas to press against an upper surface of the annular piston.

16. The method of claim 10, further comprising:
after the step of introducing gas to press against an upper surface of the annular piston, removing the process seal coupler and the cap from the disposable cartridge and removing the disposable cartridge from the cylindrical separator bowl.
